(19) United States
(12) Patent Application Publication
(10) Pub. No.: US 2025/0168746 A1
(43) Pub. Date: May 22, 2025

(54) METHOD AND APPARATUS FOR PREVENTING UE FROM BIDDING DOWN TO RESTRICTED RAT TYPE

(71) Applicant: SAMSUNG ELECTRONICS CO., LTD., Suwon-si (KR)

(72) Inventors: Rajavelsamy RAJADURAI, Bengaluru (IN); Nivedya Parambath SASI, Bengaluru (IN); Rohini RAJENDRAN, Bengaluru (IN)

(21) Appl. No.: 18/957,249

(22) Filed: Nov. 22, 2024

(30) Foreign Application Priority Data
Nov. 22, 2023 (IN) 202341079410
Nov. 8, 2024 (IN) 202341079410

(51) Int. Cl. H04W 48/02; H04W 60/04; H04W 84/04

(52) U.S. Cl. CPC H04W 48/02; H04W 60/04; H04W 84/042

(57) ABSTRACT

Embodiments herein relates to preventing UE from bidding down to restricted RAT type. The method includes determining, by network apparatus, restricted RAT types based on a network policy associated with network operator and subscription data. The RAT types can be a 5G, 4G, 3G, and 2G. Further, the method includes transmitting RAT restriction information in signalling message or configuration message to indicate the restricted RAT types to the UE to prevent the UE camping on to the restricted RAT types.

### CROSS-REFERENCE TO RELATED APPLICATIONS

This application is based on and derives the benefit of Indian Patent Application (PS) No. 202341079410 filed on Nov. 22, 2023, and Indian Patent Application (CS) No. 202341079410, filed Nov. 8, 2024, in the Indian Intellectual Property Office, the disclosure of which are incorporated by reference herein in their entirety.

### BACKGROUND

### 1. Field

The provided embodiments relate to a telecommunication network system. More particularly, the present disclosure relates to preventing UE from bidding down to 2G/3G network. Fifth generation (5G) mobile communication technologies define broad frequency bands to enable high transmission rates and new services, and can be implemented not only in “Sub 6 GHz” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (e.g., 95 GHz to 3THz bands) in order to accomplish transmission rates fifty times faster than 5G mobile communication technologies and ultra-low latencies one-tenth of 5G mobile communication technologies.

### 2. Description of Related Art

In the initial stage of 5G mobile communication technologies, in order to support services and to satisfy performance requirements in connection with enhanced mobile broadband (eMBB), ultra reliable & low latency communications (URLLC), and massive machine-type communications (mMTC), there has been ongoing standardization regarding beamforming and massive multiple-input multiple-output (MIMO) for alleviating radio-wave path loss and increasing radio-wave transmission distances in mmWave, numerology (for example, operating multiple subcarrier spacings) for efficiently utilizing mm Wave resources and dynamic operation of slot formats, initial access technologies for supporting multi-beam transmission and broadbands, definition and operation of bandwidth part (BWP), new channel coding methods, such as a low density parity check (LDPC) code for large-capacity data transmission and a polar code for highly reliable transmission of control information, layer 2 (L2) pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for securing coverage in an area in which communication with terrestrial networks is unavailable, and positioning.

Moreover, there has been ongoing standardization in wireless interface architecture/protocol fields regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service fields regarding a 5G baseline architecture (for example, service based architecture or service based interface) for combining network functions virtualization (NFV) and software-defined networking (SDN) technologies, and mobile edge computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), or the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for securing coverage in terahertz bands of 6G mobile communication technologies, full dimensional MIMO (FD-MIMO), multi-antenna transmission technologies, such as array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

The evolution of mobile communication technologies has been marked by the gradual phasing out of older standards in favor of more advanced and efficient systems. The shutdown of 2G and 3G networks is a part of this global trend, as operators and countries prepare to adopt newer technologies such as 5G and even anticipate the future deployment of 6G. The Global Mobile Suppliers Association (GSA) has identified numerous operators worldwide that have either announced or completed the shutdown of their 2G and/or 3G networks. Despite being introduced in 1991 and serving as a foundation for mobile communication for decades, 2G is now considered outdated, with some providers beginning to close down their networks as early as 2017. However, there remains a divergence in strategy, as certain carriers continue to operate 2G networks, citing reasons such as coverage and compatibility with existing devices.

The transition away from 2G and 3G networks presents several challenges, particularly in terms of security and connectivity. One significant concern is the vulnerability of devices to fake base station attacks, which exploit the weaker encryption and lack of authentication inherent in 2G and 3G networks. These attacks can intercept calls and messages, leading to privacy breaches and potential fraud. The absence of base station authentication in 2G networks allows attackers to impersonate legitimate base stations, making it possible for them to conduct bidding down attacks. Such attacks can redirect a device from a secure 4G or 5G network to a less secure 2G or 3G network, exposing sensitive information like the International Mobile Subscriber Identity (IMSI) and enabling tracking of the user equipment (UE).

Moreover, users are often provided with the option to manually disable 2G connectivity on their devices to mitigate these security risks. However, this solution is not without drawbacks. Disabling 2G can render a device out of service in regions where 2G is the only available network for voice calls or where roaming requires 2G connectivity. This limitation highlights the need for a more sophisticated mechanism that allows the network to determine the supported wireless generation and guide the UE accordingly, based on factors such as location, radio conditions, and device capabilities.

In addition to security concerns, the prioritization of available networks is another area that requires attention. When powered on, a UE performs PLMN selection, ideally choosing its home public land mobile network (HPLMN). However, the process involves various factors, including operator and user-controlled PLMN selectors, which can influence the prioritization of one network over another. The automatic selection algorithm typically favors the HPLMN or equivalent networks, but challenges arise when the UE encounters 2G/3G networks, which may still be prioritized in certain scenarios.

Given these challenges, there is a pressing need for solutions that address the security vulnerabilities associated with 2G and 3G networks, ensure seamless connectivity in areas where these networks are still in use, and optimize network selection processes to prioritize more secure and efficient technologies. Such solutions would not only enhance the security and reliability of mobile communications but also provide a more robust framework for the ongoing transition to newer generations of wireless technology.

### SUMMARY

The principal object of the embodiments herein is to prevent the UE from bidding down to a 3G/3G network.

Another object of the present disclosure is to indicate to the UE not to camp on restricted radio access technology (RAT) types during the registration procedure.

Another object of the present disclosure is to indicate to the UE information regarding supported RAT types and/or restricted RAT types during UE parameter updates via UDM and/or steering of the roaming procedure and/or UE configuration updates triggered by AMF.

Another object of the present disclosure is to preconfigure the UE from the UICC with information on supported network types/technology (such as 4G and/or 5G and/or higher generation (6G)) and/or restricted network types/technology (such as 2G and/or 3G network).

Yet another object of the present disclosure is to indicate to the UE the information on supported network types/technology (such as 4G and/or 5G and/or higher generation (6G)) and/or restricted network types/technology (such as 2G and/or 3G network) during non-access stratum (NAS) establishment and/or access stratum (AS) establishment.

Yet another object of the present disclosure is to reuse the ABBA parameter to indicate the information on supported network types/technology (such as 4G and/or 5G and/or higher generation (6G)) and/or restricted network types/technology (such as 2G and/or 3G network).

Yet another object of the present disclosure is to determine the restricted (not allowed) network types/technology (such as 2G and/or 3G network) and/or available (allowed) network types/technology (such as 4G and/or 5G network and/or higher generation (6G)) based on the PLMN support (for example, the entire PLMN provides service over the 5G technology; in this case, the network indicates not to select or camp on the 2G/3G/4G cell for the PLMN) based on the TAI, based on the RAN-based notification area (RNA), based on the nearby cell, based on geographical location (no 2G/3G in urban areas and available in rural areas), based on time, based on the CAG ID, based on CSG ID, and/or ACL and/or OCL like so.

Additional aspects will be set forth in part in the description which follows and, in part, will be apparent from the description, or may be learned by practice of the presented embodiments.

In an aspect, the objectives are achieved by providing a method for preventing user equipment (UE) from bidding down to restricted RAT types. The method includes determining by a network apparatus restricted RAT types based on a network policy associated with a network operator and subscription data. The RAT types are 5G, 4G, 3G, and 2G. Further, the method includes transmitting by the network apparatus a RAT restriction information in a signaling message or a configuration message to indicate the restricted RAT types to the UE to prevent the UE from camping on to the restricted RAT types.

In an embodiment, the network apparatus is an access and mobility management function (AMF), unified data management (UDM), eNodeB, or gNodeB.

In an embodiment, the method to transmit the RAT restriction information in a signaling message or a configuration message to indicate the restricted RAT types to the UE to prevent the UE from camping on to the restricted RAT types includes receiving by the network apparatus a registration request message from the UE to establish a connection with the network apparatus. Further, the method includes determining by the network apparatus the restricted RAT types based on the subscription data received from the UDM. Further, the method includes transmitting by the network apparatus the RAT restriction information in a registration accept response message to indicate restricted RAT types to the UE to prevent the UE from camping on to the restricted RAT types.

In an embodiment, the method to transmit the RAT restriction information in a signaling message or a configuration message to indicate restricted RAT types to the UE includes transmitting by the network apparatus the RAT restriction information to indicate restricted RAT types to a universal integrated circuit card (UICC) message.

In an embodiment, the RAT restriction information to indicate restricted RAT types is transmitted to the UE from UICC during a pre-configuration of the UE with the network apparatus. The pre-configuration message is specific to the UE based on the subscription data and device capability.

In an embodiment, the method to transmit the RAT restriction information in a signaling message or a configuration message to indicate the restricted RAT types to the UE includes receiving by the network apparatus a non-access stratum (NAS) message from the UE indicating an occurrence of an event at the UE. Further, the method includes transmitting by the network apparatus the RAT restriction information in a NAS response message based on the network policy to indicate the restricted RAT types to the UE.

In an embodiment, the method includes transmitting by the network apparatus a redirection security policy information to the UE during attach accept and tracking area update accept to protect the UE against redirection of the UE on the restricted RAT types.

In an embodiment, the method includes transmitting by the network apparatus a configuration update to the UE indicating information about an updated restricted RAT type.

In an embodiment, the method to transmit the RAT restriction information in a signaling message or a configuration message to indicate the restricted RAT types to the UE includes receiving by the network apparatus an access stratum request message from the UE indicating an occurrence of an event. Further, the method includes transmitting by the network apparatus the RAT restriction information in an AS response message based on the network policy to indicate the restricted RAT types to the UE.

In an embodiment, the method to transmit the RAT restriction information in a signaling message or a configuration message to indicate the restricted RAT types to the UE includes receiving by the network apparatus the RAT restriction information in an SDM notification message to indicate the restricted RAT types from the UDM during UE parameter update (UPU) or steering of roaming (SoR) procedure. Further, the method includes transmitting by the network apparatus the RAT restriction information in a down link (DL) NAS transport message to indicate the restricted RAT types to the UE.

Accordingly, the embodiment herein is to provide a method for preventing UE from bidding down to restricted RAT types. The method includes determining by a UE whether a RAT restriction information is supported. The UE stores a list of public land mobile network (PLMNs) with associated RAT restrictions. Further, the method includes receiving by the UE a RAT restriction information in a signaling message or a configuration message to indicate the restricted RAT types from network apparatus when the UE supports the RAT restriction information. The RAT types are 5G, 4G, 3G, and 2G. Further, the method includes storing by the UE the RAT restriction information for the associated PLMN indicating the restricted RAT types. Further, the method includes skip selecting by the UE the PLMNs associated with RAT restrictions indicated in the signaling message or the configuration message.

In an embodiment, the network apparatus is an access and mobility management function (AMF), unified data management (UDM), eNodeB, or gNodeB.

In an embodiment, the method to skip selecting the PLMNs associated with RAT restrictions indicated in the signaling message or the configuration message includes transmitting by the UE a registration request message to the network apparatus to establish a connection with the network apparatus. Further, the method includes receiving by the UE the RAT restriction information in the registration accept response message to indicate the restricted RAT types from the network apparatus. Further, the method includes skip selecting by the UE the PLMNs associated with RAT restrictions indicated in the registration accept response message.

In an embodiment, the method to skip selecting the PLMNs associated with RAT restrictions indicated in the signaling message or the configuration message includes receiving by the UE the RAT restriction information in a pre-configuration message to indicate the restricted RAT types from the network apparatus or UICC. The pre-configuration message is specific to the UE based on the subscription data and device capability. Further, the method includes skip selecting by the UE the PLMNs associated with RAT restrictions indicated in the pre-configuration message.

In an embodiment, the method to skip selecting the PLMNs associated with RAT restrictions indicated in the signaling message or the configuration message includes transmitting by the UE a NAS message to the network apparatus to indicate an occurrence of an event. Further, the method includes receiving by the UE the RAT restriction information in a NAS response message to indicate the restricted RAT types from the network apparatus. Further, the method includes skip selecting by the UE the PLMNs associated with RAT restrictions indicated in the NAS response message.

In an embodiment, the method includes receiving by the UE a redirection security policy information from the network apparatus during attach accept procedure and TAU accept procedure to protect from redirecting the connection with the restricted RAT types. Further, the method includes skip selecting by the UE the PLMNs associated with RAT restrictions indicated in the redirection security policy information.

In an embodiment, the method of skip selecting the PLMNs associated with RAT restrictions indicated in the signaling message or the configuration message includes receiving by the UE the RAT restriction information in a configuration update message from the network apparatus to configure the UE with updated configurations to indicate the restricted RAT types. Further, the method includes skip selecting by the UE the PLMNs associated with RAT restrictions indicated in the configuration update message.

In an embodiment, the method of skip selecting the PLMNs associated with RAT restrictions indicated in the signaling message or the configuration message includes transmitting by the UE an AS request message to the network apparatus to indicate an occurrence of an event. Further, the method includes receiving by the UE the RAT restriction information in an AS response message from the network apparatus to indicate the restricted RAT types. Further, the method includes skip selecting by the UE the PLMNs associated with RAT restrictions indicated in the AS response message.

In an embodiment, the method of skip selecting the PLMNs associated with RAT restrictions indicated in the signaling message or the configuration message includes receiving by the UE the RAT restriction information in a down link (DL) NAS transport message during configuration update procedure to indicate the restricted RAT types. Further, the method includes skip selecting by the UE the PLMNs associated with RAT restrictions indicated in the DL NAS transport message.

Accordingly, the embodiment herein is to provide a network apparatus for preventing UE from bidding down to restricted RAT type network. The network apparatus includes a processor and a RAT type indication controller communicatively coupled to the processor. Further, the RAT type indication controller determines restricted RAT types based on a network policy associated with a network operator and subscription data. The RAT types include 5G, 4G, 3G, and 2G. Further, the RAT type indication controller transmits a RAT restriction information in a signaling message or a configuration message to indicate the restricted RAT types to the UE to prevent the UE from camping on to the restricted RAT types.

Accordingly, the embodiment herein is to provide a UE for bidding down to restricted RAT type. The UE includes a processor and a RAT type indication controller. The RAT type indication controller determines whether a RAT restriction information is supported. The UE stores a list of public land mobile network (PLMNs) with associated RAT restrictions. Further, the RAT type indication controller receives a RAT restriction information in a signaling message or a configuration message to indicate the restricted RAT types from network apparatus when the UE supports the RAT restriction information. The RAT types are 5G, 4G, 3G, and 2G. Further, the RAT type indication controller stores the RAT restriction information for the associated PLMN indicating the restricted RAT types. Further, the RAT type indication controller skips selecting the PLMNs associated with RAT restrictions indicated in the signaling message or the configuration message.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein. The term “2G” can be understood as GSM and CDMAOne access technology, similarly “3G” as UMTS and CDMA2000 access technology, “4G” as LTE and WiMAX access technology and “5G” as 5G New Radio (NR) access technology.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

For a more complete understanding of the present disclosure and its advantages, reference is now made to the following description taken in conjunction with the accompanying drawings, in which like reference numerals represent like parts:

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 illustrates a network apparatus for preventing UE from bidding down to restricted RAT types according to embodiments of the present disclosure;

FIG. 2 illustrates a UE for preventing from bidding down to restricted RAT types according to embodiments of the present disclosure;

FIG. 3 illustrates a flowchart of a method for preventing UE from bidding down to restricted RAT types by network apparatus according to embodiments of the present disclosure;

FIG. 4 illustrates a flowchart of a method for preventing from bidding down to restricted RAT types by UE according to embodiments of the present disclosure;

FIG. 5 illustrates a sequence diagram of a scenario where UE is indicated information about RAT type restriction during registration according to embodiments of the present disclosure;

FIG. 6 illustrates a sequence diagram of a scenario where UICC is (pre) configured with information about RAT type restriction by UDM according to embodiments of the present disclosure;

FIG. 7 illustrates a sequence diagram of a scenario where the UE is indicated information about RAT type restriction in a NAS message according to the embodiments of the present disclosure;

FIG. 8 illustrates a sequence diagram of a procedure where the UE is indicated information about RAT type restriction in a NAS security mode command message according to the embodiments of the present disclosure;

FIG. 9 illustrates a sequence diagram of a scenario where the UE is indicated information about RAT type restriction in an AS message according to the embodiments of the present disclosure;

FIG. 10 illustrates a sequence diagram of a procedure where the UE is indicated information about RAT type restriction in an RRC connection reconfiguration message according to the embodiments of the present disclosure; and

FIG. 11 illustrates a sequence diagram of a procedure where UE is indicated information about RAT type restriction during UPU or SoR procedure according to embodiments of the present disclosure.

It may be noted that, to the extent possible, like reference numerals have been used to represent like elements in the drawing. Furthermore, those of ordinary skill in the art will appreciate that elements in the drawing are illustrated for simplicity and may not necessarily have been drawn to scale. For example, the dimensions of some of the elements in the drawing may be exaggerated relative to other elements to improve the understanding of aspects of the present disclosure. Further, the elements may have been represented in the drawing by conventional symbols, and the drawings may show only those specific details that are pertinent to understanding the embodiments of the present disclosure so as not to obscure the drawing with details that will be readily apparent to those of ordinary skill in the art having the benefit of the description herein.

### DETAILED DESCRIPTION

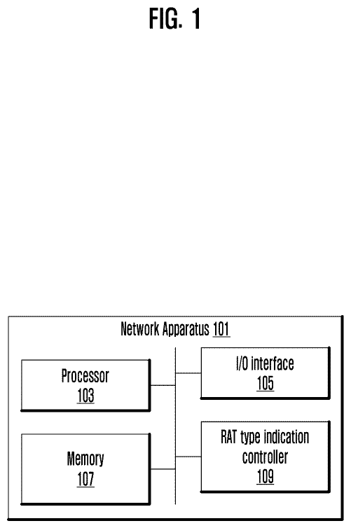

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

It may be noted that, to the extent possible, like reference numerals have been used to represent like elements in the drawing. Furthermore, those of ordinary skill in the art will appreciate that elements in the drawing are illustrated for simplicity and may not necessarily have been drawn to scale. For example, the dimensions of some of the elements in the drawing may be exaggerated relative to other elements to improve the understanding of aspects of the present disclosure. Further, the elements may have been represented in the drawing by conventional symbols, and the drawings may show only those specific details that are pertinent to understanding the embodiments of the present disclosure so as not to obscure the drawing with details that will be readily apparent to those of ordinary skill in the art having the benefit of the description herein.

As is traditional in the field, embodiments are described and illustrated in terms of blocks that carry out a described function or functions. These blocks, which are referred to herein as managers, units, modules, hardware components, or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware and software. The circuits, for example, may be embodied in one or more semiconductor chips or on substrate supports such as printed circuit boards and the like. The circuits constituting a block may be implemented by dedicated hardware or by a processor (e.g., one or more programmed microprocessors and associated circuitry) or by a combination of dedicated hardware to perform some functions of the block and a processor to perform other functions of the block. Each block of the embodiments may be physically separated into two or more interacting and discrete blocks without departing from the scope of the provided method. Likewise, the blocks of the embodiments may be physically combined into more complex blocks without departing from the scope of the provided method.

The accompanying drawings are used to help easily understand various technical features, and it is understood that the embodiments presented herein are not limited by the accompanying drawings. As such, the provided method is construed to extend to any alterations, equivalents, and substitutes in addition to those which are particularly set out in the accompanying drawings. Although the terms “first,” “second,” etc. are used herein to describe various elements, these elements are not limited by these terms. These terms are generally used to distinguish one element from another. Further, the term “2G” can be understood as GSM and CDMAOne access technology, similarly “3G” as UMTS and CDMA2000 access technology, “4G” as LTE and WiMAX access technology and “5G” as 5G new radio (NR) access technology.

Referring now to the drawings and more particularly to FIGS. 1 through 11, where similar reference characters denote corresponding features consistently throughout the figure, these are shown preferred embodiments.

FIG. 1 illustrates a network apparatus for preventing UE from bidding down to restricted RAT types according to embodiments of the present disclosure. The network apparatus (101) includes a processor (103), a memory (107), an I/O interface (105), and a radio access technology type indication controller (109). Furthermore, the processor (103) of the network apparatus (101) communicates with the memory (107), the I/O interface (105), and the RAT type indication controller (109). The processor (103) is configured to execute instructions stored in the memory (107) and to perform various processes. The processor (103) can include one or a plurality of processors, can be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

Furthermore, the memory (107) of the network apparatus (101) includes storage locations that can be addressed through the processor (103). The memory (107) is not limited to volatile or non-volatile memory and can include one or more computer-readable storage media. Non-volatile storage elements such as magnetic hard disks, optical discs, floppy discs, flash memories, EPROM, or EEPROM memories can also be included in the memory (107). Further, the memory (107) of the network apparatus (101) can store various information received from the UE. The network apparatus (101) stores the one or more information such as network policy associated with network operators and subscription data.

The I/O interface (105) transmits information between the memory (107) and external peripheral devices, which are input-output devices associated with the network apparatus (101). The I/O interface (105) receives various information from the UE and core network. This information can include, but is not limited to, network policy associated with network operators and subscription data.

The RAT type indication controller (109) communicates with the I/O interface (105) and memory (107) for preventing the UE from bidding down to restricted RAT types. The RAT type indication controller (109) is an innovative hardware that is realized through the physical implementation of both analog and digital circuits, including logic gates, integrated circuits, microprocessors, microcontrollers, memory circuits, passive and active electronic components, as well as optical components. The network apparatus (101) can be at least one of the network functions such as AMF, UDM, eNodeB, and gNodeB.

The RAT type indication controller (109) of the network apparatus (101) determines the restricted RAT types based on the network policy associated with the network operator and the subscription data. The RAT types can include, but are not limited to, 5G, 4G, 3G, and 2G. The determination process involves analyzing the subscription data stored in the Unified Data Management (UDM) system, which contains user-specific information such as service level agreements and access restrictions. The network policy may also consider factors like network congestion, security protocols, and service prioritization to decide which RAT types may be restricted. Further, the RAT type indication controller (109) transmits a RAT restriction information, the signaling message, or the configuration message to indicate the restricted RAT types to the UE to prevent the UE from camping on to the restricted RAT types. This transmission is crucial for ensuring that the UE operates within the network's defined parameters, thereby optimizing network resources and maintaining service quality.

Particularly, the RAT type indication controller (109) of the network apparatus (101) receives the registration request message from the UE to establish a connection with the network apparatus (101). This registration request typically includes the UE's identity, capabilities, and current RAT type. Further, the RAT type indication controller (109) determines the restricted RAT types based on the subscription data received from the UDM. The controller may utilize algorithms to match the UE's capabilities with the network's current operational status and policies. Upon determination, the RAT type indication controller (109) transmits the RAT restriction information in a registration accept response message to indicate the restricted RAT types to prevent the UE from camping on to the restricted RAT types. For example, the restricted types can include, but are not limited to, 2G and 3G, which might be limited due to their lower data rates and security features compared to newer technologies like 4G and 5G.

Also, the RAT type indication controller (109) transmits the RAT restriction information to indicate the restricted RAT types to the UICC message. The UICC, or Universal Integrated Circuit Card, acts as a secure element that stores network-specific information and user credentials. The RAT restriction information is transmitted to the UE from the UICC during the pre-configuration message, which is specific to the UE based on the subscription data and the device capability. This ensures that the UE is pre-configured with the necessary restrictions before the UE attempts to access the network, thereby reducing the risk of unauthorized access or inefficient network usage.

The RAT type indication controller (109) receives the NAS message from the UE indicating the occurrence of the event at the UE. This event could be a change in location, a request for a specific service, or a change in the UE's operational state. Further, the RAT type indication controller (109) transmits the RAT restriction information in the NAS response message based on the network policy to indicate the restricted RAT types to the UE. The NAS response message is crucial for maintaining synchronization between the UE and the network, ensuring that the UE adheres to the latest network policies and restrictions.

Also, the RAT type indication controller (109) transmits the redirection security policy information to the UE during attach accept and Tracking Area Update accept to protect the UE against redirection of the UE on the restricted RAT types. This security policy information includes encryption keys and authentication parameters that prevent unauthorized redirection attempts. By implementing these security measures, the network can safeguard against potential threats and ensure that the UE remains connected to the most appropriate RAT type.

The RAT type indication controller (109) transmits the configuration update to the UE indicating information about an updated restricted RAT type. This update is essential when there are changes in network policy or when new RAT types are introduced or deprecated. The configuration update may include details such as the effective date of the restriction, the rationale behind the restriction, and any alternative RAT types that the UE can utilize. By keeping the UE informed of these updates, the network ensures seamless connectivity and optimal performance.

The RAT type indication controller (109) receives the access stratum request message from the UE indicating an occurrence of an event. This message typically includes information about the UE's current state, such as the UE's location, signal strength, and service requirements. Further, the RAT type indication controller (109) transmits the RAT restriction information in the AS response message based on the network policy to indicate the restricted RAT types to the UE. The AS response message is critical for managing the UE's access to the network, ensuring that the message complies with the latest restrictions and policies.

The RAT type indication controller (109) receives the RAT restriction information in the SDM notification message to indicate the restricted RAT types from the UDM during UPU or SoR procedure. The UPU and SoR procedures are essential for maintaining accurate records of the UE's activities and ensuring that the UE receives the appropriate level of service. Further, the RAT type indication controller (109) indicates the restricted RAT types to the UE by transmitting the RAT restriction information in the DL NAS transport message. This message serves as a final confirmation of the restricted RAT types, ensuring that the UE is fully aware of the network's current policies and restrictions.

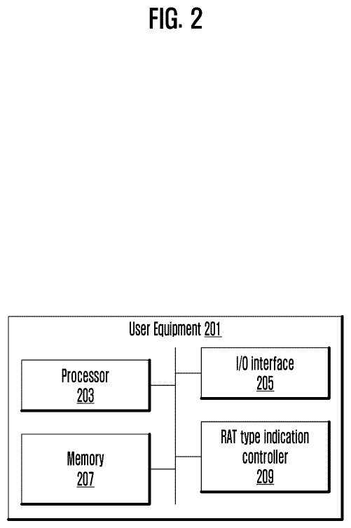

FIG. 2 illustrates a UE for preventing bidding down to restricted RAT types according to embodiments of the present disclosure. The UE (201) includes a processor (203), a memory (207), an I/O interface (205), and a RAT type indication controller (209). Furthermore, the processor (203) of the UE (201) communicates with the memory (207), the I/O interface (205), and the RAT type indication controller (209). The processor (203) is configured to execute instructions stored in the memory (207) and to perform various processes. The processor (203) can include one or a plurality of processors, can be a general-purpose processor such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU).

Furthermore, the memory (207) of the UE (201) includes storage locations that can be addressed through the processor (203). The memory (207) is not limited to volatile or non-volatile memory and can include one or more computer-readable storage media. Non-volatile storage elements such as magnetic hard disks, optical discs, floppy discs, flash memories, EPROM, or EEPROM memories can also be included in the memory (207). Further, the memory (207) of the UE (201) can store various information received from the network apparatus (101). The UE (201) stores the one or more information such as supported network types and restricted network types. For example, the supported network types can be 4G, 5G, and higher generations. Similarly, the restricted network types can be, but not limited to, 2G and 3G.

The I/O interface (205) transmits information between the memory (207) and external peripheral devices, which are input-output devices associated with the UE (201). The I/O interface (205) receives various information from the network apparatus. This information can include, but is not limited to, network policy associated with network operators and subscription data.

The RAT type indication controller (209) communicates with the I/O interface (205) and memory (207) for preventing the UE (201) from bidding down to restricted RAT types. The RAT type indication controller (209) is an innovative hardware that is realized through the physical implementation of both analog and digital circuits, including logic gates, integrated circuits, microprocessors, microcontrollers, memory circuits, passive and active electronic components, as well as optical components.

The RAT type indication controller (209) of the UE (201) determines whether the RAT restriction information is supported. This involves checking the device's firmware and software capabilities to ensure compatibility with the network's RAT control protocols. The UE (201) stores the list of PLMNs with associated RAT restrictions, which are dynamically updated based on network broadcasts and user preferences. Further, the RAT type indication controller (209) receives the RAT restriction information in the signaling message or the configuration message to indicate the restricted RAT types from network apparatus. This information element (IE) is crucial for the UE to adapt the connectivity strategy, ensuring compliance with network policies. The UE (201) supports the RAT restriction information, allowing the UE to seamlessly switch between different RATs as dictated by network conditions and policies. The RAT types can include but are not limited to 5G, 4G, 3G, and 2G, each with distinct characteristics such as bandwidth, latency, and coverage. Further, the RAT type indication controller (209) stores the RAT restriction information for the associated PLMN indicating the restricted RAT types, ensuring that the UE does not attempt to connect using unsupported or restricted technologies. Further, the RAT type indication controller (209) skips selecting the PLMNs associated with RAT restrictions indicated in the signaling message or the configuration message, optimizing the UE's network selection process and conserving battery life by avoiding futile connection attempts.

The RAT type indication controller (209) of the UE (201) transmits the registration request message to the network apparatus (101) to establish the connection with the network apparatus (101). This message includes the UE's capabilities and preferences, allowing the network to tailor the network's response accordingly. Further, the RAT type indication controller (209) receives the RAT restriction information in the registration accept response message to indicate the at least one restricted RAT types from the network apparatus (101). This ensures that the UE is immediately aware of any limitations imposed by the network, allowing the UE to adjust the UE's operation to maintain compliance. Further, the RAT type indication controller (209) skips selecting the PLMNs associated with RAT restrictions indicated in the registration accept response message, thereby streamlining the connection process and reducing the likelihood of connection failures.

Also, the RAT type indication controller (209) receives the RAT restriction information in the pre-configuration message to indicate the restricted RAT types from the network apparatus (101) or UICC. This pre-configuration message is tailored to the UE (201) based on the subscription data and the device capability, ensuring that the device operates within the parameters set by the network and the user's service plan. Further, the RAT type indication controller (209) skips selecting the PLMNs associated with RAT restrictions indicated in the pre-configuration message, which helps in maintaining efficient network usage and adherence to subscription terms.

The RAT type indication controller (209) transmits the NAS message to the network apparatus (101) to indicate an occurrence of the event. This message may include information about the UE's current state, such as location updates or service requests. Further, the RAT type indication controller (209) receives the RAT restriction information in the NAS response message to indicate the restricted RAT types from the network apparatus (101). This feedback loop allows the UE to continuously adapt to the network's operational constraints. Further, the RAT type indication controller (209) skips selecting the PLMNs associated with RAT restrictions indicated in the NAS response message, ensuring that the UE remains within the operational boundaries set by the network.

The RAT type indication controller (209) receives the redirection security policy information from the network apparatus (101) during the attach accept procedure and TAU accept procedure to protect from redirecting the connection with the restricted RAT types. This security policy is crucial for preventing unauthorized access and ensuring that the UE only connects to approved networks. Further, the RAT type indication controller (209) skips selecting the PLMNs associated with RAT restrictions indicated in the redirection security policy information, thereby enhancing the security and reliability of the UE's network connections.

The RAT type indication controller (209) receives the RAT restriction information in the configuration update message from the network apparatus (101) to configure the UE (201) with updated configurations to indicate the restricted RAT types. This update process ensures that the UE remains aligned with the latest network policies and technological advancements. Further, the RAT type indication controller (209) skips selecting the PLMNs associated with RAT restrictions indicated in the configuration update message, optimizing the UE's performance and network compatibility.

The RAT type indication controller (209) transmits the AS request message to the network apparatus (101) to indicate an occurrence of the event. This message may trigger specific network actions, such as resource allocation or service adjustments. Further, the RAT type indication controller (209) receives the RAT restriction information in the AS response message from the network apparatus (101) to indicate the restricted RAT types. This interaction ensures that the UE is always operating within the network's current operational framework. Further, the RAT type indication controller (209) skips selecting the PLMNs associated with RAT restrictions indicated in the AS response message, maintaining efficient and compliant network usage.

The RAT type indication controller (209) receives the RAT restriction information in the DL NAS transport message during the configuration update procedure to indicate the restricted RAT types. This message is part of the ongoing communication between the UE and the network to ensure that the device's configuration is always up-to-date. Further, the RAT type indication controller (209) skips selecting the PLMNs associated with RAT restrictions indicated in the DL NAS transport message, ensuring that the UE's network selection process remains efficient and aligned with network policies.

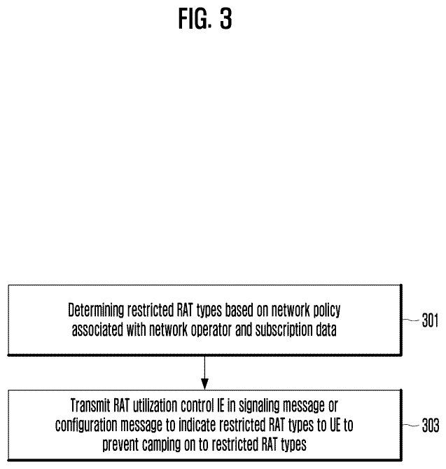

FIG. 3 illustrates a flowchart Of a method for preventing UE from bidding down to restricted RAT types by network apparatus according to embodiments of the present disclosure. At block 301, the method includes determining at least one restricted RAT type based on at least one of a network policy associated with the network operator and the subscription data. The RAT types can include 5G, 4G, 3G, and 2G. At block 303, the method includes transmitting the RAT restriction information in the signaling message or the configuration message to indicate the restricted RAT types to the UE (201) to prevent the UE (201) from camping on the restricted RAT types.

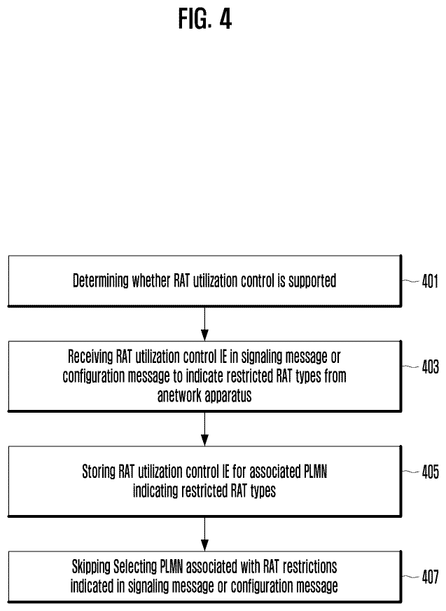

FIG. 4 illustrates a flowchart of a method for preventing from bidding down to restricted RAT types by UE according to embodiments disclosed herein. At block 401, the method includes determining whether the RAT restriction information is supported. The UE (201) stores a list of PLMNs with associated RAT restrictions. At block 403, the method includes receiving the RAT restriction information in the signaling message or the configuration message to indicate the restricted RAT types from network apparatus (101) when the UE (201) supports the RAT restriction information. The RAT types can include, but are not limited to, 5G, 4G, 3G, and 2G. At block 405, the method includes storing the RAT restriction information for the associated PLMN indicating the restricted RAT types. At block 407, the method includes skipping selecting the PLMNs associated with RAT restrictions indicated in the signaling message or the configuration message.

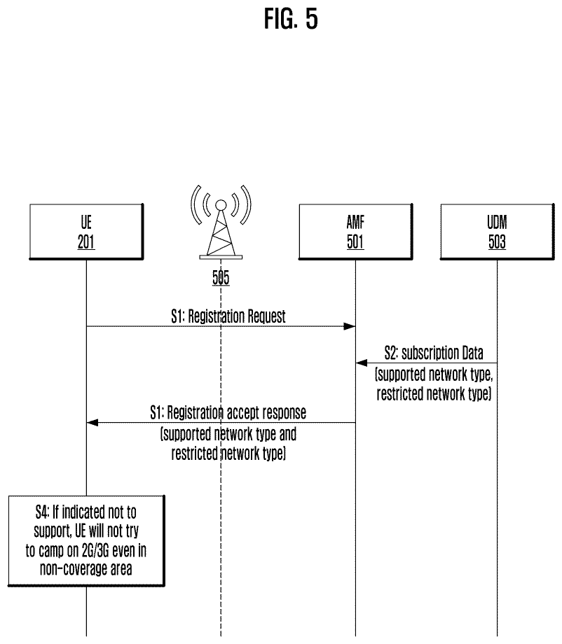

FIG. 5 illustrates a sequence diagram of a scenario where the UE is indicated information about RAT type restriction during registration according to embodiments of the present disclosure. As shown in FIG. 5, it is assumed that the network operator does not support 2G/3G technologies and prefers the UE (201) subscribed to the network not to camp on a 2G/3G network (maybe even in the case of a non-coverage area when automatic network selection is enabled). Based on the indication received, the UE (201) may indicate to the user that the PLMN/MNO/Operator's network does not support certain technologies if the user selects the network in Manual Network Selection Mode Procedure.

At step S1, the UE (201) initiates the registration procedure (as specified in 3GPP TS 23502) by sending a registration request message to the AMF (501). The UE (201) includes the necessary parameters required for the registration in this message. At step S2, as part of the Registration procedure (as specified in 3GPP TS 23502), the Home Network (HN) UDM (503) provides the AMF (501) with the subscription data. In an embodiment, the subscription data additionally may include information on supported network type/technology (for example, such as 4G and/or 5G and/or higher generation (6G)) and/or restricted network types/technology (for example, such as 2G and/or 3G network).

In an embodiment, the UDM (503) is configured with the supported and/or restricted network type/technology for the entire network and/or specific to a user (subscriber) based on subscription (premium/post-paid subscription 2G and/or 3G is restricted and normal/prepaid subscription as a backup 2G and/or 3G is allowed to manage load balancing in 5G) and/or based on the device (for example, IoT/wearable device is allowed to access 2G and/or 3G and Smartphone is not allowed to access 2G and/or 3G). At step S3, the AMF (501) provides the received information on supported network type/technology (for example, such as 4G and/or 5G and/or higher generation (6G)) and/or restricted network types/technology (for example, such as 2G and/or 3G network) to the UE (201) in a Registration accept message. At step S4, if it is indicated by the HN that particular network type(s)/technology(ies) (for example, such as 4G and/or 5G and/or higher generation (6G)) is allowed and/or particular network technology(ies) is restricted/not supported network type(s)/technology(ies) (for example, such as 2G and/or 3G network), then the UE (201) may not try to camp on restricted/not supported network type/technology even in a non-coverage area or camp only in the supported/allowed network type/technology.

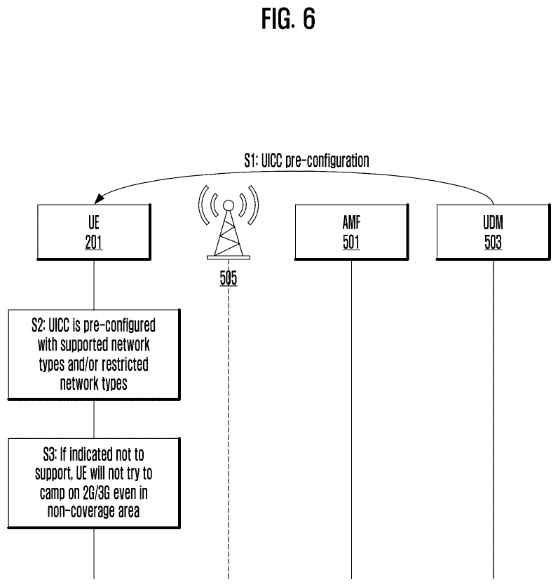

FIG. 6 illustrates a sequence diagram of a scenario where the UICC is (pre) configured with information about RAT type restriction by UDM according to embodiments of the present disclosure. At step S1&S2, the home network (pre), which is the UDM (503), configures the UICC with supported network type/technology (for example, such as 4G and/or 5G and/or higher generation (6G)) and/or restricted network types/technology (for example, such as 2G and/or 3G network). In an embodiment, the network is configured with the supported and/or restricted network type/technology for the entire network and/or specific to a user (subscriber) based on subscription (premium/post-paid subscription 2G is restricted and normal/pre-paid subscription as a backup 2G is allowed to manage load balancing in 5G) and/or based on the device (for example, IoT/wearable device is allowed to access 2G and Smartphone is not allowed to access 2G).

In an embodiment, the UICC is (pre) configured with this information along with other parameters before distribution to the subscriber. In an embodiment, the network apparatus (101) provisions the UICC with such configuration via Over-the-air provisioning methods. At step S3, the UE (201) in possession of the information on particular network type/technology is allowed and/or particular network technology is restricted/not supported may not try to camp on restricted/not supported network type/technology even in a non-coverage area or camp only in the supported/allowed network type/technology.

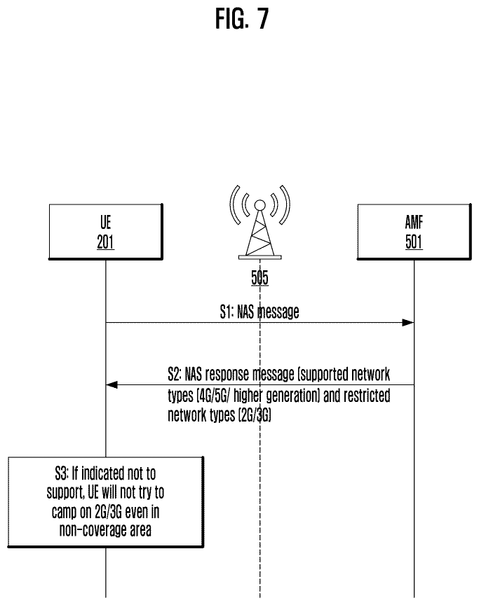

FIG. 7 illustrates a sequence diagram of a scenario where the UE is indicated information about RAT type restriction in a NAS message according to the embodiments of the present disclosure. At step S1, based on the trigger and/or occurrence of an event, the UE (201) initiates the NAS procedure with the AMF (501) (as specified in 3GPP standard specification TS 23.502) (for example, based on the TAI change, the UE (201) initiates a mobility registration procedure). At step S2, in an embodiment, the network apparatus (101) (for example, AMF (501)) is configured with the supported and/or restricted network type/technology for the entire network and/or specific to a TAI and/or list of TAIs and/or CAG ID and/or CSG ID and/or location like so.

Based on the network policy (for example, on the PLMN and/or TAI granularity), the AMF (501) provides the configured information on supported network type/technology (for example, such as 4G and/or 5G and/or higher generation (6G)) and/or restricted network types/technology (for example, such as 2G and/or 3G network) to the UE (201) in a NAS response message for the received NAS request message. In an embodiment, the AMF (501) obtains the configuration from another network function (NF), for example, from PCF and/or from operations administration and maintenance (OAM) server and/or AUSF and/or UDM and/or NEF like so. The PCF and/or OAM server and/or AUSF and/or UDM and/or NEF are configured with the supported and/or restricted network type/technology for the entire network and/or specific to a TAI and/or list of TAIs and/or CAG ID and/or CSG ID and/or location like so.

At step S3, if it is indicated by the AMF (501) that the particular network type/technology (for example, such as 4G and/or 5G and/or higher generation (6G)) is allowed and/or particular network technology is restricted/not supported network types/technology (for example, such as 2G and/or 3G network), then the UE (201) may not try to camp on restricted/not supported network type/technology even in a non-coverage area or camp only in the supported/allowed network type/technology.

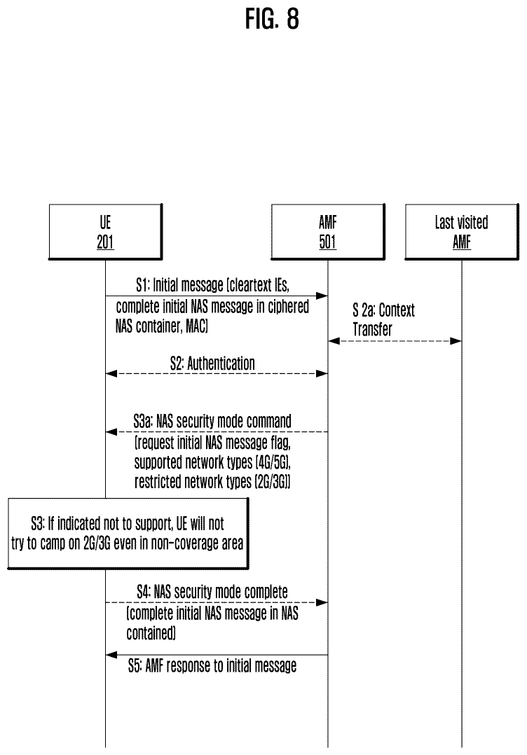

FIG. 8 illustrates a sequence diagram of a procedure where the UE is indicated information about RAT type restriction in a NAS security mode command message according to the embodiments of the present disclosure. As shown in FIG. 8, the NAS SMC procedure illustrates the UE (201) is indicated (step 3a) with the information on network type(s)/technology(ies) (for example, such as 4G and/or 5G and/or higher generation (6G)) is allowed and/or particular network technology(ies) is restricted/not supported network type(s)/technology(ies) (for example, such as 2G and/or 3G network) by the AMF (501) in any NAS security mode command.

If it is indicated (step 3b) by the AMF (501) that the particular network type/technology (for example, such as 4G and/or 5G and/or higher generation (6G)) is allowed and/or particular network technology is restricted/not supported network types/technology (for example, such as 2G and/or 3G network), then the UE (201) may not try to camp on restricted/not supported network type/technology even in a non-coverage area or camp only in the supported/allowed network type/technology. In an embodiment, the AMF (501) can provide redirection security policy information to the UE (201) during attach accept and TAU accept to protect against redirection on the UE (201) side. Thus, the UE (201) can apply the security policy and reject an unauthenticated redirection to 2G.

In an embodiment, similar to the NAS SMC procedure, using the AS SMC procedure, the gNB (505) provides the indication to the UE (201). In an embodiment, UE (201) configuration on the supported and/or restricted network type(s)/technology(ies) may be updated by the network apparatus (101) at any time, for example, using the UE Configuration Update procedure (where the network initiates the procedure without a request from the UE).

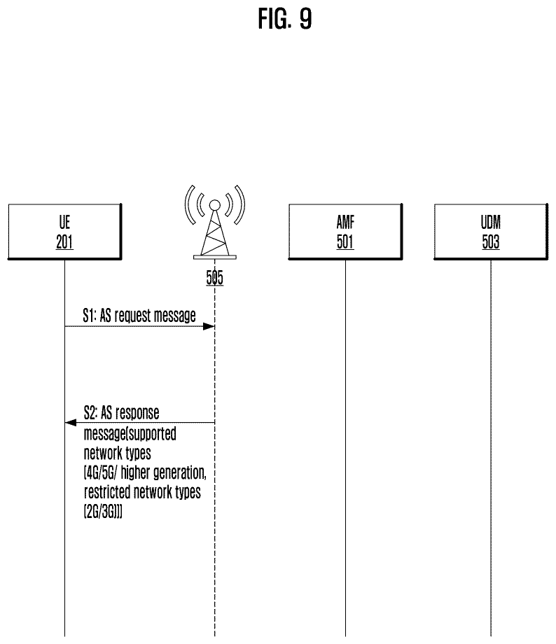

FIG. 9 illustrates a sequence diagram of a scenario where the UE is indicated information about RAT type restriction in an AS message according to embodiments of the present disclosure. At step S1, based on the trigger and/or occurrence of an event, the UE (201) initiates an AS/RRC procedure with the gNB (505) (as specified in TS 38400) (for example, based on the RNA change, the UE (201) initiates an RRC procedure). At step S2, in an embodiment, the network apparatus (101) (for example, gNB (505)) is configured with the supported and/or restricted network type/technology for the entire network and/or specific to an RNA and/or list of RNAs and/or CAG ID and/or CSG ID and/or location like so. Based on the network policy (for example, on the PLMN and/or RNA granularity), the gNB (505) provides the configured information on supported network type/technology (for example, such as 4G and/or 5G and/or higher generation (6G)) and/or restricted network types/technology (for example, such as 2G and/or 3G network) to the UE (201) in an RRC response message for the received RRC request message. In an embodiment, the gNB (101) obtains the configuration from another network function (NF), for example, from AMF (501) and/or from Operations Administration and Maintenance (OAM) server like so. If it is indicated by the gNB (505) that the particular network type(s)/technology(ies) (for example, such as 4G and/or 5G and/or higher generation (6G)) is allowed and/or particular network technology is restricted/not supported network type(s)/technology(ies) (for example, such as 2G and/or 3G network), then the UE (201) may not try to camp on restricted/not supported network type/technology even in a non-coverage area or camp only on the supported/allowed network type/technology.

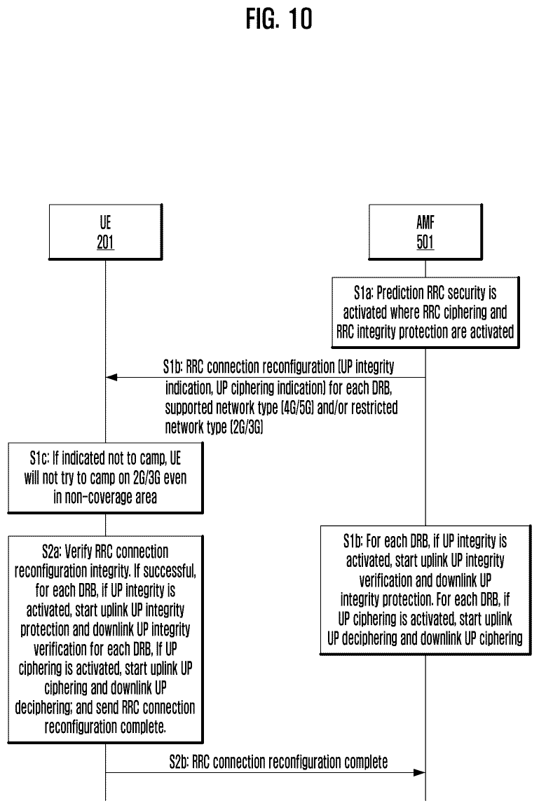

FIG. 10 illustrates a sequence diagram of a procedure where the UE is indicated information about RAT type restriction in an RRC connection reconfiguration message according to the embodiments of the present disclosure. FIG. 10 illustrates the indication over the RRC connection reconfiguration where the UE (201) is indicated (step 1b) with the information on network type(s)/technology(ies) (for example, such as 4G and/or 5G and/or higher generation (6G)) is allowed and/or particular network technology(ies) is restricted/not supported network type(s)/technology(ies) (for example, such as 2G and/or 3G network) by the gNB in the RRC connection reconfiguration message. If it is indicated (step 3b) by the AMF (501) that the particular network type/technology (for example, such as 4G and/or 5G and/or higher generation (6G)) is allowed and/or particular network technology is restricted/not supported network types/technology (for example, such as 2G and/or 3G network), then the UE (201) may not try to camp on restricted/not supported network type/technology even in a non-coverage area or camp only on the supported/allowed network type/technology.

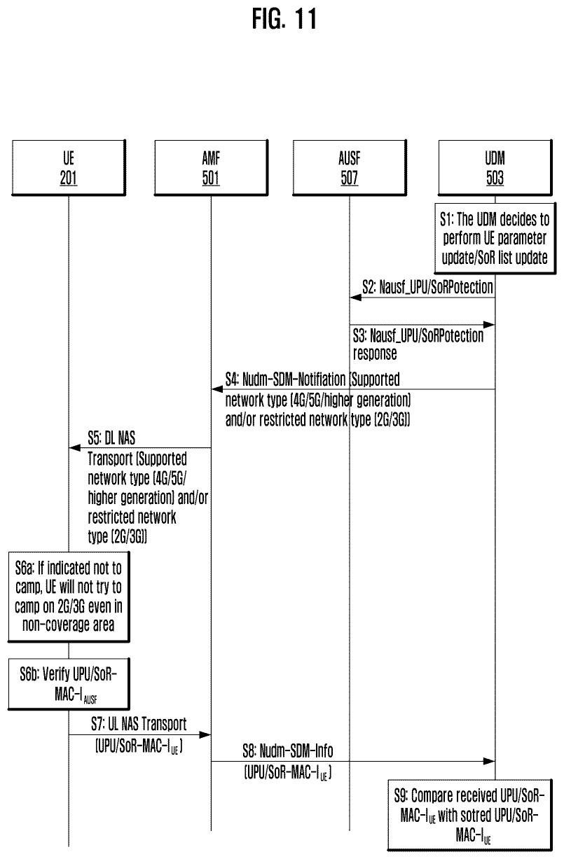

FIG. 11 illustrates a sequence diagram of a procedure where UE is indicated information about RAT type restriction during UPU or SoR procedure according to embodiments of the present disclosure.

At steps S1 to S3, UDM (703) decides to perform UE parameter update (UPU) or steering of roaming (SoR) list update.

At step S4, the UDM (703) provides the AMF (501) with the information on supported network type/technology (for example, such as 4G and/or 5G and/or higher generation (6G)) and/or restricted network types/technology (for example, such as 2G and/or 3G network) in Nudm_SDM_notification message.

At step S5, the AMF (501) provides the received information on supported network type/technology (for example, such as 4G and/or 5G and/or higher generation (6G)) and/or restricted network types/technology (for example, such as 2G and/or 3G network) to the UE (201) in DL NAS transport message during configuration update procedure.

At step S6, if it is indicated by the HN that particular network type(s)/technology(ies) (for example, such as 4G and/or 5G and/or higher generation (6G)) is allowed and/or particular network technology(ies) is restricted/not supported network type(s)/technology(ies) (for example, such as 2G and/or 3G network), then the UE (201) may not try to camp on restricted/not supported network type/technology even in non-coverage area or camp only on the supported/allowed network type/technology. On receiving the DL NAS Transport message, the UE (201) may calculate the UPU-MAC-IAUSF as specified in 3GPP standard specification TS 33501.

At steps S7 to S9, the procedure follows UPU or SoR procedure as defined in 3GPP standard specification TS 33501. In an embodiment, the SoR transparent container contains a preferred PLMN and access technology list where the UE (201) may not consider other Access Technology for the listed PLMN. In an embodiment, the SoR transparent container contains a preferred PLMN and access technology list and also may include the not allowed access technology for the preferred PLMN list.

In an embodiment, the ABBA parameter is provided to the UE (201) from SEAF. As shown in TABLE 1, the SEAF sets the ABBA parameter to 0x0000, which corresponds to the initial set of security features defined for 5G. The SEAF further sets the ABBA parameter value as 0xYYYA, which indicates that the UE (201) is restricted to connect to 2G/3G network types, and/or as 0xYYYB, which indicates that the UE (201) is allowed to connect to only 5G networks, and/or as 0xYYYC, which indicates that the UE is only allowed to connect to 5G networks and higher generation (6G).

TABLE 1
Values for ABBA parameter

| ABBA parameter value | Description |
|---|---|
| 0xYYYA | Restricted to connect to 2G/3G networks. |
| 0xYYYB | Only 5G allowed |
| 0xYYYC | 5G and above allowed |

In an embodiment, UE (201) is provided with the information on supported network type/technology (for example, such as 4G and/or 5G and/or higher generation (6G)) and/or restricted network types/technology (for example, such as 2G and/or 3G network) in a secure message. In an embodiment, the UE (201) need not consider the redirection command in case the command/information is received in unsecure messages.

In an embodiment, when the UE (201) initiates a registration procedure with the AMF (501), the AMF (501) may redirect the UE (201) from 5GC to any lower generation (such as 2G and/or 3G network) (similarly, the gNB may redirect the UE). If the UE (201) receives a redirect message in an unprotected message, then UE (201) may ignore the redirection request to mitigate bidding down attack. In an embodiment, if the UE (201) receives a redirect message in a protected message, then UE (201) may honor the redirection request to continue the service in the redirected network.

In an embodiment, it is possible for the MNO to provide service only via 4G and not via other access technologies like 2G/3G/5G. In this case, the UE is indicated with the information of supported network types/technology as 4G and/or restricted network types/technology as 2G and/or 3G and/or 5G and/or higher generation access technology.

The various actions, acts, blocks, steps, or the like in the FIGS. 1-11 are performed in the order presented, in a different order, or simultaneously. Furthermore, in some embodiments, some of the actions, acts, blocks, steps, or the like are omitted, added, modified, skipped, or the like without departing from the scope of the provided method.

The foregoing description of the specific embodiments will fully reveal the general nature of the embodiments herein such that others can readily modify and/or adapt such specific embodiments for various applications without departing from the generic concept. Therefore, such adaptations and modifications are intended to be comprehended within the meaning and range of equivalents of the disclosed embodiments. It is to be understood that the phraseology or terminology employed herein is for the purpose of description and not of limitation. Thus, while the embodiments herein have been described in terms of preferred embodiments, those skilled in the art will recognize that the embodiments herein can be practiced with modifications within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a network entity in a communication system, the method comprising:
determining at least one radio access technology (RAT) to be restricted for an access of a terminal; and
transmitting, to the terminal, a message including information on the at least one RAT to be restricted.

2. The method of claim 1, wherein the network entity is at least one of an entity for a mobility management, an access and mobility management function (AMF), or a base station.

3. The method of claim 1, wherein the message comprises at least one of an attach accept message, a tracking area update accept message, a registration accept message, or a configuration update command message.

4. The method of claim 1, wherein the at least one RAT comprises at least one of 2nd generation (2G) RAT, 3G RAT, 4G RAT, or 5G RAT.

5. The method of claim 1, wherein the at least one RAT is associated with a public land mobile network (PLMN).

6. A method performed by a terminal in a wireless communication system, the method comprising:
receiving, from a network entity, a message including information on at least one radio access technology (RAT) to be restricted for an access of the terminal;
storing the information on the at least one RAT to be restricted for an associated public land mobile network (PLMN); and
determining not considering the at least one RAT as PLMN selection candidates.

7. The method of claim 6, wherein the network entity is at least one of an entity for a mobility management, an access and mobility management function (AMF), or a base station.

8. The method of claim 6, wherein the message comprises at least one of an attach accept message, a tracking area update accept message, a registration accept message, or a configuration update command message.

9. The method of claim 6, wherein the at least one RAT comprises at least one of 2nd generation (2G) RAT, 3G RAT, 4G RAT, or 5G RAT.

10. The method of claim 6, further comprising:
determining that the terminal supports a restriction of a RAT.

11. A network entity in a communication system, the network entity comprising:
a transceiver; and
a controller configured to:
determine at least one radio access technology (RAT) to be restricted for an access of a terminal, and
transmit, to the terminal via the transceiver, a message including information on the at least one RAT to be restricted.

12. The network entity of claim 11, wherein the network entity is at least one of an entity for a mobility management, an access and mobility management function (AMF), or a base station.

13. The network entity of claim 11, wherein the message comprises at least one of an attach accept message, a tracking area update accept message, a registration accept message, or a configuration update command message.

14. The network entity of claim 11, wherein the at least one RAT comprises at least one of 2^{nd} generation (2G) RAT, 3G RAT, 4G RAT, or 5G RAT.

15. The network entity of claim 11, wherein the at least one RAT is associated with a public land mobile network (PLMN).

16. A terminal in a wireless communication system, the terminal comprising:
a transceiver; and
a controller configured to:
receive, from a network entity via the transceiver, a message including information on at least one radio access technology (RAT) to be restricted for an access of the terminal,
store the information on the at least one RAT to be restricted for an associated public land mobile network (PLMN), and
determine not considering the at least one RAT as PLMN selection candidates.

17. The terminal of claim 16, wherein the network entity is at least one of an entity for a mobility management, an access and mobility management function (AMF), or a base station.

18. The terminal of claim 16, wherein the message comprises at least one of an attach accept message, a tracking area update accept message, a registration accept message, or a configuration update command message.

19. The terminal of claim 16, wherein the at least one RAT comprises at least one of 2^{nd} generation (2G) RAT, 3G RAT, 4G RAT, or 5G RAT.

20. The terminal of claim 16, wherein the controller is further configured to:
determine that the terminal supports a restriction of a RAT.
